(19) United States
(12) Patent Application Publication
(10) Pub. No.: US 2004/0175223 A1
(43) Pub. Date: Sep. 9, 2004

(54) Cosmetic pencil

(76) Inventor: Grant Lloyd Berry, Armonk, NY (US)

Correspondence Address: AKERMAN SENTERFITT, P.O. BOX 3188, WEST PALM BEACH, FL, 33402-3188, US

(21) Appl. No.: 10/379,278

(22) Filed: Mar. 4, 2003

(51) Int. Cl. B43K 19/14; B43K 19/02

(52) U.S. Cl. 401/96

(57) ABSTRACT

A cosmetic pencil including a wooden shaft having an elliptic, or oval-shaped, longitudinally extending channel filled with a cosmetic core. Following sharpening, a smooth continuous inwardly tapering cosmetic core tip is formed terminating at a curved edge. The cosmetic pencil tip configuration enables application of thin lines of the cosmetic in a first marking direction and thick lines of the cosmetic in a second perpendicular making direction

### BACKGROUND OF THE INVENTION

1. Field of the Invention

The present invention relates generally to cosmetics. More particularly, the present invention relates to cosmetic pencils used to apply eye shadow, eye liner, lipstick, lip liner and the like.

2. Description of the Prior Art

Cosmetic pencils are well known in the art of cosmetics for applying eye shadow, eye liner, lipstick and lip liner. Typically, cosmetic pencils are comprised of a cylindrical cosmetic stick, or lead, encased within a pencil shaft. Referring briefly to FIG. 1, a conventional prior art cosmetic pencil 2 generally includes a cylindrical shaft 4 encasing a cylindrical cosmetic lead 8, wherein, upon sharpening, a conical lead tip 10, terminating at a point, extends from a tapered pencil end 6. When using such a conventional cosmetic pencil, the resulting line thickness is a direct function of the lead thickness, and more particularly the contact area of the lead tip point with the skin.

Generally, thin cosmetic pencils (also referred to in the art as “slimline” pencils) are used where it is desired to apply thin lines of cosmetic, akin to lip liner and eye liner applications. On the other hand, thick cosmetic pencils (also referred to in the art as “jumbo” pencils) are used where it is desired to apply relatively thick lines of cosmetic, akin to lipstick and eye shadow applications. Cosmetic pencils have grown in popularity to such an extent that many consumers prefer to use cosmetic pencils for all of their makeup applications. As a consequence of the aforementioned line width limitation of conventional cosmetic pencils, consumers desiring to use cosmetic pencils for applications requiring both thin and thick lines must possess multiple pencils.

In lieu of using multiple cylindrical cosmetic pencils each having a different lead thickness, it would be advantageous to provide a single cosmetic pencil capable of applying both thick and thin lines of a cosmetic composition such that the single pencil could be used to replicate the look of eye liner, lip liner, eye shadow and lip stick. It would also be desirable to provide such a cosmetic pencil incorporating a lead tip functioning as a kajal liner for lining the inside lower and upper eye lids, wherein the surface geometry of the tip substantially minimizes the potential for eye injuries during such applications vis-à-vis conventional cosmetic pencils having cylindrical lead points. It would be further desirable to provide such a cosmetic pencil including a shaft having a geometry lending itself to improved user handling and control during a cosmetic application.

### SUMMARY OF THE INVENTION

The present invention is generally directed to a cosmetic pencil enabling precise application of a cosmetic composition such as eye shadow, eye liner, lipstick, lip liner and the like, to the skin of a user. When applied in a first marking direction, the cosmetic pencil can apply exceptionally thin lines of a cosmetic material not currently achievable with conventional cosmetic pencils. When applied in a second marking direction, the cosmetic pencil can apply thick lines of cosmetic. Additionally, the structure of the lead tip is such that it enables improved control and precision during eye shadow and lipstick applications, as well as better shading and blending vis-à-vis conventional cylindrical cosmetic pencils.

In a general aspect of the present invention, a cosmetic pencil is provided comprising a shaft having a non-cylindrical, and preferably elliptic, longitudinally extending channel filled with a cosmetic composition.

In another aspect of the invention, an end of the pencil is sharpened to form a cosmetic core tip having an inwardly tapering flattened conoid geometry terminating at an edge.

In yet another aspect of the invention, the particular surface geometry of the cosmetic core tip enables application of both fine lines and thick lines of cosmetic material by merely altering the orientation of the tip relative to the marking direction.

In a further aspect of the present invention, the core tip has a somewhat flat major surface for facilitating application of eye shadow to the eyelids and lipstick to the lips of a user.

In yet a further aspect of the invention, the outer surface of the cosmetic pencil shaft has an elliptic shape for providing improved user handling and control.

In still another aspect of the invention, the pencil shaft is comprised of a pair of wooden slats each having a longitudinally extending groove particularly shaped such that, upon adhesively coupling the slats to each other, the grooves form a longitudinally extending elliptic channel for receiving a corresponding elliptic cosmetic lead.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a perspective elevation view of an exemplary prior art cosmetic pencil having a cylindrical cosmetic lead;

FIG. 2 is a perspective elevation view of the cosmetic pencil of the present invention with its protective cap removed;

FIG. 3 is a perspective elevation view of the cosmetic pencil of FIG. 2, with the protective cap attached;

FIG. 4 is a top plan view of the assembled cosmetic pencil and cap of the present invention;

FIG. 5 is a rear end view of the cosmetic pencil of FIG. 6;

FIG. 6 is a top plan view of the cosmetic pencil of the present invention with the protective cap removed;

FIG. 7 is a front end view of the cosmetic pencil of FIG. 6;

FIG. 8 is a top plan view of the cosmetic pencil protective cap;

FIG. 9 is a front end view of the protective cap of FIG. 8;

FIG. 10 is an elevated side view of the cosmetic pencil and cap assembly of FIG. 4;

FIG. 11 is a rear end view of the cosmetic pencil of FIG. 12;

FIG. 12 is an elevated side view of the cosmetic pencil of the present invention with the protective cap removed;

FIG. 13 is a front end view of the cosmetic pencil of FIG. 12;

FIG. 14 is an elevated side view of the cosmetic pencil protective cap;

FIG. 15 is a front end view of the protective cap of FIG. 14;

FIG. 16 is a cross-sectional view taken along cutting plane 16-16 of FIG. 12;

FIG. 17 is an exploded perspective view illustrating the interior structure and configuration of the cosmetic pencil of the present invention;

FIGS. 18 and 19 illustrate the use of the cosmetic pencil for varying the thickness of a line marking by merely altering the orientation of the pencil vis-à-vis the marking surface; and

FIG. 20 is a perspective view illustrating the surface geometry of the core tip of the cosmetic pencil of the present invention.

### DETAILED DESCRIPTION OF THE PREFERRED EMBODIMENTS

Shown throughout the figures, the present invention is generally directed to a cosmetic pencil having a non-cylindrical, and preferably elliptic, cosmetic core wherein a sharpened end of the pencil has a geometry enabling application of a thin line of cosmetic material in a first marking direction and a thick line of the cosmetic material in a second marking direction.

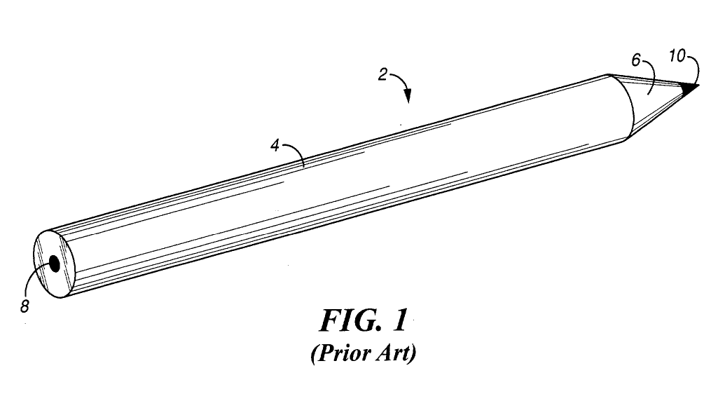

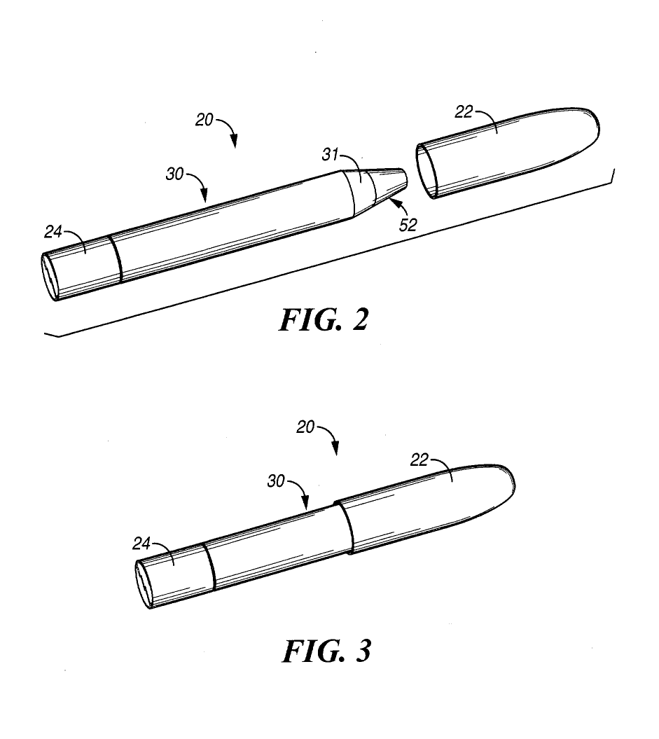

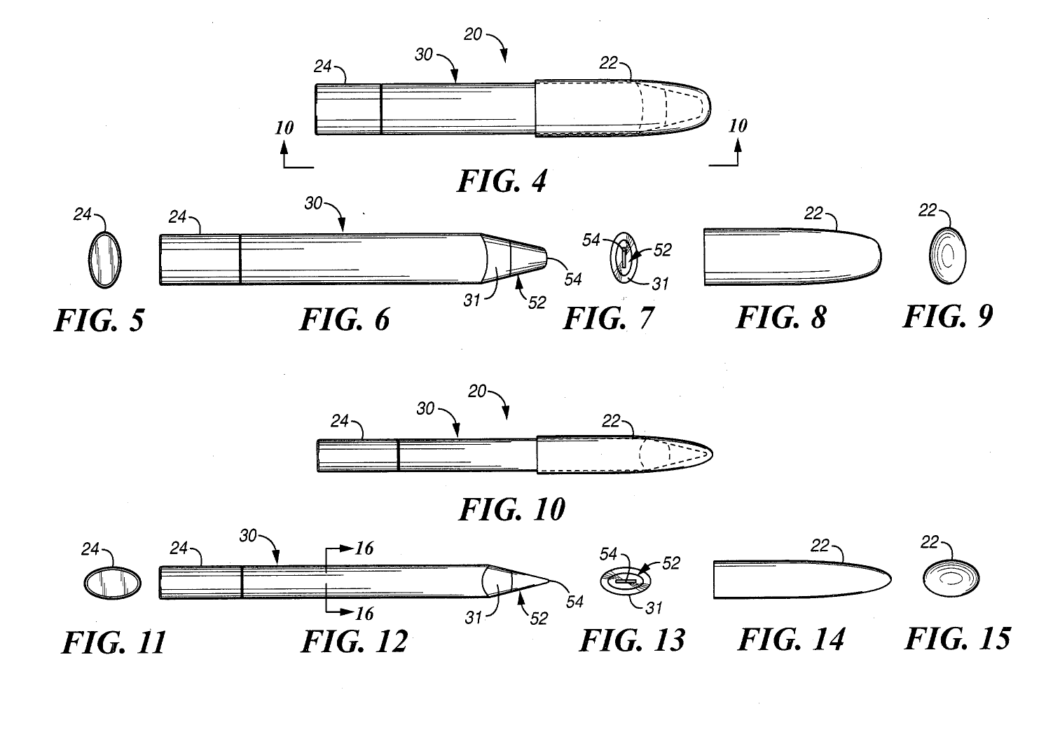

Referring initially to FIGS. 1 and 2, the cosmetic pencil assembly of the present invention, shown generally as reference numeral 20, includes a cosmetic pencil 30 having a tail cap 24 covering a rear pencil end, and a protective cap 22 covering a marking end. A cosmetic core tip 52 extends distally from an inwardly tapered surface portion 31 of the pencil.

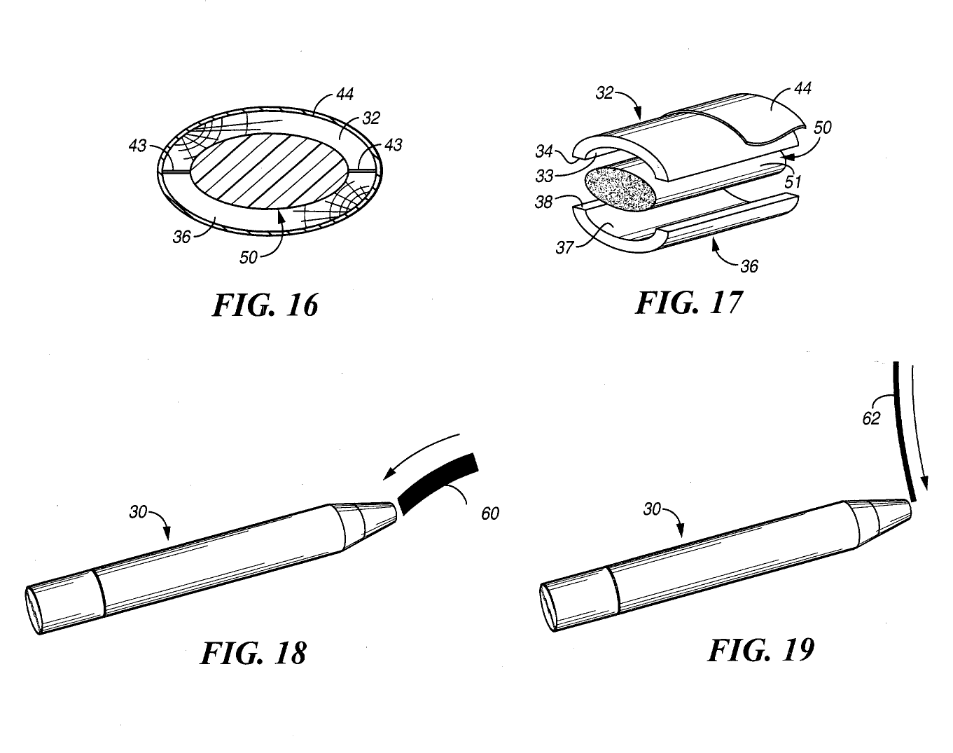

Referring briefly to FIGS. 16 and 17, a preferred cosmetic pencil construction will now be described. The cosmetic pencil has a shaft constructed from a pair of wooden slats, 32 and 36, separated along an axial plane, which are glued to each other by a layer of adhesive 43 interposed between adjoining surfaces, 34 and 38, of the respective slats. The slats, 32 and 36, have generally C-shaped longitudinally extending grooves, 33 and 37, respectively, which form a longitudinally extending elliptic, or oval-shaped, channel when the slats are joined. The elliptic channel is completely filled with a desired cosmetic composition, preferably in the form of a prefabricated cosmetic stick 50. A lacquer 44 or similar coating is preferably provided over the outer surface of the wood shaft.

The manufacture of the longitudinal halves of the shaft and the joining of these halves to one another, sandwiching the cosmetic lead, is well known to those skilled in the art of cosmetic pencil manufacturing. Generally, the cosmetic core 50 is initially fabricated by extruding a cosmetic composition through an extrusion aperture having the desired geometry. Significantly, in the present invention the cosmetic composition is extruded through a somewhat flattened elliptic aperture. Following extrusion, the cosmetic lead is preferably coated with a talc powder and positioned between the wooden slats 32, 36 in alignment with the grooves 33, 37. The slats are glued together by adhesive layer 42 interposed between the adjacent slat surfaces 34, 38 and then the entire construction is pressed together. The pencils are typically subjected to one or more coating/decorating operations and then sharpened using a sharpening apparatus particularly designed for the cosmetic pencil construction of the present invention.

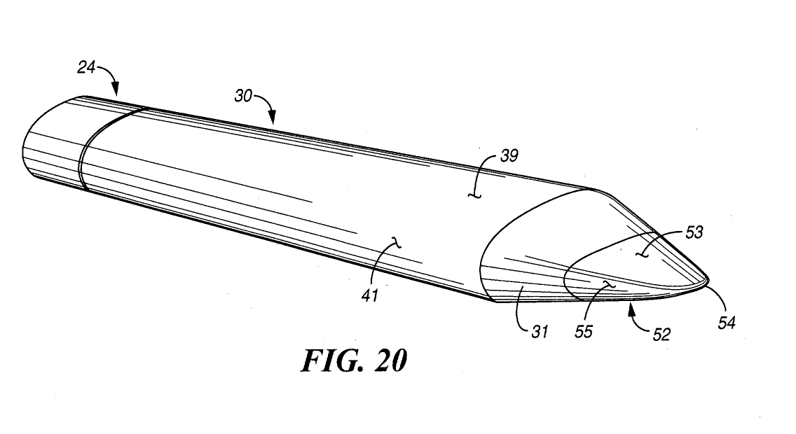

Referring to FIGS. 4-15 and 20 the cosmetic pencil 30 is sharpened to form a flush, or smooth, transition from the resulting tapered pencil surface 31 to the corresponding resulting inwardly-tapered exterior surface of the cosmetic core tip 52. The cosmetic core tip 52 has a unique geometry vis-à-vis existing cosmetic pencils. As shown in FIG. 1, the cosmetic pencils of the prior art are purely conical; that is, the outer surface has a substantially fixed linear inward taper terminating at a point. In stark contrast, the cosmetic core tip 52 of the cosmetic pencil of the present invention is elongated and has a substantially flattened elliptic, or oval-shaped, cross-section terminating distally at a sharp edge 54. Preferably, edge 54 is slightly rounded, or convex. Referring now particularly to FIG. 20, the inwardly tapering exterior surface of the core tip 52 includes somewhat flat, although slightly convex, major surface portions 53 separated by convex minor surface portions 55. The surface geometry of the cosmetic core tip 52 is a critical feature of the present invention.

Referring to FIGS. 18 and 19, the core tip surface geometry enables application of both thin cosmetic lines as well as thick cosmetic lines. As shown in FIG. 18, when the cosmetic core tip 52 is rubbed against a marking surface in a direction perpendicular to tip edge 54 (as indicated by the arrow) a thick line 60 is formed. This type of marking is particularly desirable for cosmetic lipstick and eye shadow applications. Alternatively, as shown in FIG. 19, when the cosmetic core tip 52 is rubbed against a marking surface in the direction of cosmetic core tip edge 54 (as indicated by the arrow) a thin line 62 results. This type of marking is particularly desirable for cosmetic lip liner and eye liner applications. Additionally, flat core tip major surface 53 enables the pencil 30 to function as a kajal liner for lining the inside lower and upper eye lids (not shown) during a make-up application. For this application, the smooth relatively large area of flat surface 53 lends itself to greater control and improved shading vis-à-vis conventional jumbo cosmetic pencils. Significantly, the smooth rounded edge 54 substantially minimizes the risk of injury to a user's eye vis-à-vis a conventional conical lead tip. In other words, although it may be possible to use the outer surface of the conical tip of a conventional pencil 1 (FIG. 1) for this purpose, this is generally not advisable due to the attendant risk of injury resulting from jabbing the eye with the sharp point at the end of the tip portion.

In contrast to prior art cosmetic pencils incorporating a cylindrical cosmetic lead having a conical tip, the structure of the cosmetic pencil of the present invention enables the safe application of both thin and thick lines of cosmetic to the user's skin. As a result, a single cosmetic pencil can be used to perform multiple cosmetic applications requiring different line thicknesses. For instance, a single cosmetic pencil can perform the dual functions of applying eye shadow and eye liner, or eye liner and lipstick. Additionally, the applicant has found that, if desired, the sharp edge 54 of the cosmetic pencil 30 of the present invention can be used to produce substantially finer lines than are possible with a conventional slimline cosmetic pencil. Furthermore, the incorporation of a cosmetic tip terminating at an edge, instead of a point, lends itself to more precise and accurate control during the application of the makeup. This improvement in control is further enhanced by the corresponding flattened elliptic shape of the outer surface 39, 41 of the pencil shaft, which shape lends itself to improved gripping and handling.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

By way of example, in lieu of using wood, the pencil shaft could be formed using polymers capable of being machined with a sharpener, including, but not limited to, polyvinyl chloride, polypropylene and acrylonitrile/butadiene/polystyrene copolymers.

What is claimed is:

1. A cosmetic pencil, comprising:
a shaft having an outer surface and a non-cylindrical channel extending longitudinally therethrough; and
a cosmetic material core completely filling said non-cylindrical channel.

2. A cosmetic pencil as recited in claim 1, further comprising a sharpened cosmetic pencil end having a smooth continuous inwardly tapering shaft length and a smooth continuous inwardly tapering cosmetic material core tip extending slightly beyond the end of said tapering shaft length.

3. A cosmetic pencil as recited in claim 2, wherein said inwardly tapering cosmetic core tip terminates at an edge configured for making line markings on a surface such that the thickness of the marked line can be varied depending upon the orientation of the core tip relative to the marking direction.

4. A cosmetic pencil as recited in claim 3, wherein the edge of said core tip has a continuous curvature.

5. A cosmetic pencil as recited in claim 4, wherein the continuous curvature of said core tip is generally parabolic.

6. A cosmetic pencil as recited in claim 1, wherein said shaft is constructed from wood.

7. A cosmetic pencil as recited in claim 6, wherein said wooden shaft further comprises a pair of wooden slats each having a longitudinally extending groove provided therein, said slats adhesively coupled to each other such that the grooves form said longitudinally extending non-cylindrical channel.

8. A cosmetic pencil as recited in claim 1, wherein the outer surface of said shaft has a non-cylindrical outer surface.

9. A cosmetic pencil as recited in claim 8, wherein the outer surface of said shaft has a shape substantially identical to the shape of said shaft channel.

10. A cosmetic pencil, comprising:
a wooden shaft having an elliptic channel extending longitudinally therethrough; and
a cosmetic material core completely filling said elliptic channel.

11. A cosmetic pencil as recited in claim 10, wherein the outer surface of said wooden shaft is elliptic.

11. A cosmetic pencil as recited in claim 10, further comprising a sharpened cosmetic pencil end having a smooth continuous inwardly tapering shaft length terminating at a smooth continuous inwardly tapering cosmetic material core tip.

12. A cosmetic pencil as recited in claim 11, wherein said inwardly tapering cosmetic core tip terminates at an edge.

13. A cosmetic pencil as recited in claim 12, wherein said inwardly tapering cosmetic core tip terminates at an edge configured for making line markings on a surface such that the thickness of the marked line varies depending upon the orientation of the core tip relative to the marking direction.

14. A cosmetic pencil as recited in claim 13, wherein the edge of said core tip produces line markings having a first width when moved in a first marking direction and a substantially greater second width when moved in a second marking direction perpendicular to the first marking direction.

15. A cosmetic pencil as recited in claim 14, wherein the edge of said core tip has a generally parabolic shape.

16. A cosmetic pencil as recited in claim 10, wherein said wooden shaft further comprises a pair of wooden slats each having a longitudinally extending groove provided therein, said slats adhesively coupled to each other such that the grooves form said longitudinally extending elliptic channel.
